(19) United States
(12) Patent Application Publication
(10) Pub. No.: US 2021/0362980 A1
(43) Pub. Date: Nov. 25, 2021

(54) Mast Climber

(71) Applicant: The Tisdale Group, LLC, Lebanon, TN (US)

(72) Inventors: Donald Wade BARKER, Hendersonville, TN (US); Josh Ireland, Nashville, TN (US); Erik Spendlove, Las Vegas, NV (US); Wyatt Mabry, Chattanooga, TN (US)

(21) Appl. No.: 17/326,651

(22) Filed: May 21, 2021

Related U.S. Application Data
(60) Provisional application No. 63/028,223, filed on May 21, 2020.

(51) Int. Cl. B66B 9/02; E04G 1/20; B66B 11/04

(52) U.S. Cl. CPC B66B 9/022; B66B 11/0461; E04G 1/20

(57) ABSTRACT

A mast climber, including a mast and a platform, is disclosed. The mast is comprised of at least two segments, including a bottom segment and one or more body segments. Each segment has a sidewall that is made of sheet metal, and most segments may be made of a lightweight metal, such as a aluminum. Each segment has at least one gear rail assembly, and may have two gear rails, disposed on opposite corners of the mast. A platform is adapted to be connected to the mast. The platform is equipped with a drive system that moves the platform up and down the mast. The drive system includes one or more electric motors on the platform and batteries to power the electric motors. Each motor has a gear that engages one of the gear rails. A backup power supply or generator may be provided.

### CROSS-REFERENCE TO RELATED APPLICATIONS

This application claims priority to, and the benefit of, U.S. Provisional Patent Application No. 63/028,223, filed May 21, 2020.

### TECHNICAL FIELD

The invention relates to mast climbers.

### BACKGROUND

Mast climbers are devices in which a powered platform ascends a mast. Used in construction, they can deliver materials and workers to particular heights along the exterior of a building more efficiently than static scaffolding.

Existing mast climbers have a number of issues. For one, the mast is usually a form of truss, constructed using steel members welded together. The sheer number of members makes welding a mast together a time-consuming task. The platform itself is usually driven by a relatively complex drive system, powered by hydraulics or a gasoline engine.

### BRIEF SUMMARY

One aspect of the invention relates to a mast climber. The mast climber includes a mast and a platform. The mast is comprised of at least two segments, including a bottom segment and one or more body segments. Each segment has a sidewall that is made of sheet metal. Each segment has at least one gear rail assembly. A platform is adapted to be connected to the mast for vertical movement along the mast. The platform is equipped with a drive system that moves the platform up and down the mast using the at least one gear rail assembly.

For example, the sidewall of the mast may be made of two pieces of sheet metal, each bent into an L-shape, and welded at two opposite corners. Each segment also has a top plate and a bottom plate. The top and bottom plates from adjacent segments are bolted together. The sidewalls of each segment may have relatively large open areas to reduce both weight and wind loading. Many of the segments may be made of a lightweight metal, such as aluminum, although in some cases, the bottom segment may be made of a stiffer material, such as steel. The mast may be provided with two gear rail assemblies on opposite corners.

Another aspect of the invention relates to the drive system of a platform in a mast climber. The drive system comprises at least one electric motor with a gear adapted to engage with the at least one gear rail assembly. The drive system also comprises at least one battery. In one embodiment, the drive system may comprise two electric motors, each of which has a gear and each of which engages a separate gear rail on the mast. A second battery may be provided. The drive system may also include a backup power source. The backup power source may be a generator that can charge the batteries and provide emergency power, or it may be a third battery capable of powering one or both of the motors for some period of time.

Other aspects, features, and advantages of the invention will be set forth in the description that follows.

### BRIEF DESCRIPTION OF THE DRAWING FIGURES

The invention will be described with respect to the following drawing figures, in which like numerals represent like features throughout the description, and in which:

FIG. 1 is a perspective view of a mast climber according to one embodiment of the invention;

FIG. 2 is a perspective view of two segments of the mast of FIG. 1, shown in isolation to illustrate their connecting structure;

FIG. 3 is a bottom plan view of the base of the mast of FIG. 1;

FIG. 4 is a side elevational view of a portion of the mast climber of FIG. 1;

FIG. 5 is a perspective view of a portion of the mast of FIG. 1, illustrating the cradle that attaches to the platform and bears on the mast;

FIG. 6 is a perspective view of a portion of the mast climber of FIG. 1, illustrating the drive system of the platform and its engagement with the mast; and

FIG. 7 is a perspective view of the underside of a portion of the mast climber, illustrating the location of certain elements of its power system.

### DETAILED DESCRIPTION

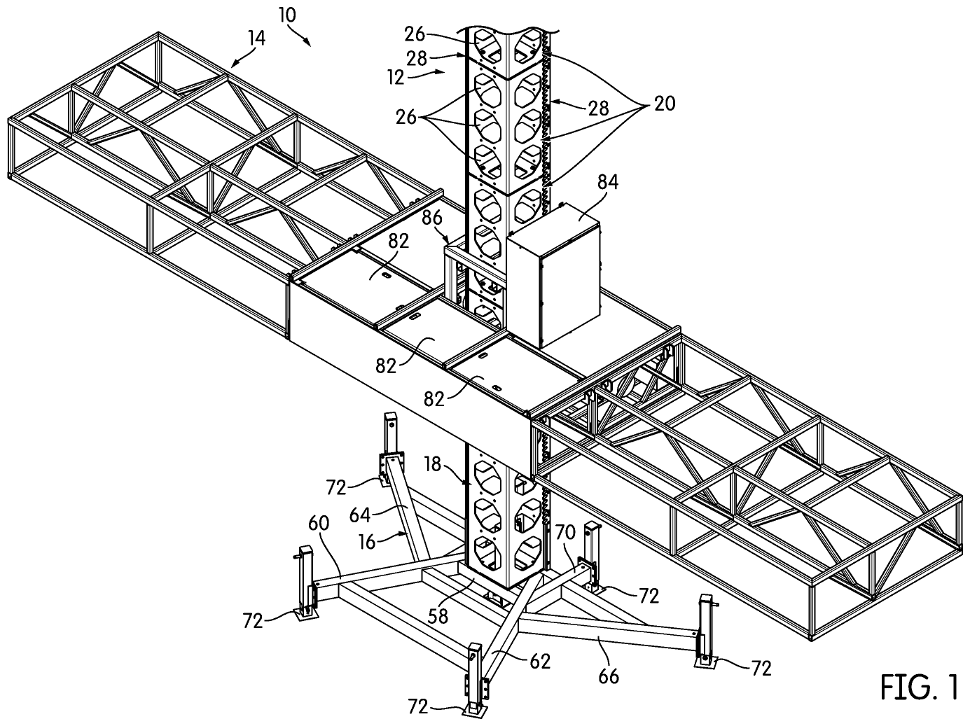

FIG. 1 is a perspective view of a mast climber, generally indicated at 10, according to one embodiment of the invention. The mast climber 10 comprises a mast 12 and a platform 14. As will be described below in more detail, the platform 14 is powered and traverses the mast 12 vertically in order to move people and materials to various heights. As will also be described below in more detail, the mast climber 10 may be operated in a freestanding mode up to a certain mast height, and may be tethered to the side of a building for greater mast heights.

### The Mast

As shown in FIG. 1, the mast 12 comprises a base 16 and a number of mast segments 18, 20 modularly connected to the base. The mast 12 has an elongate, rectilinear shape; however, the mast 12 is not comprised of a truss, and the segments 18, 20 are not truss-segments.

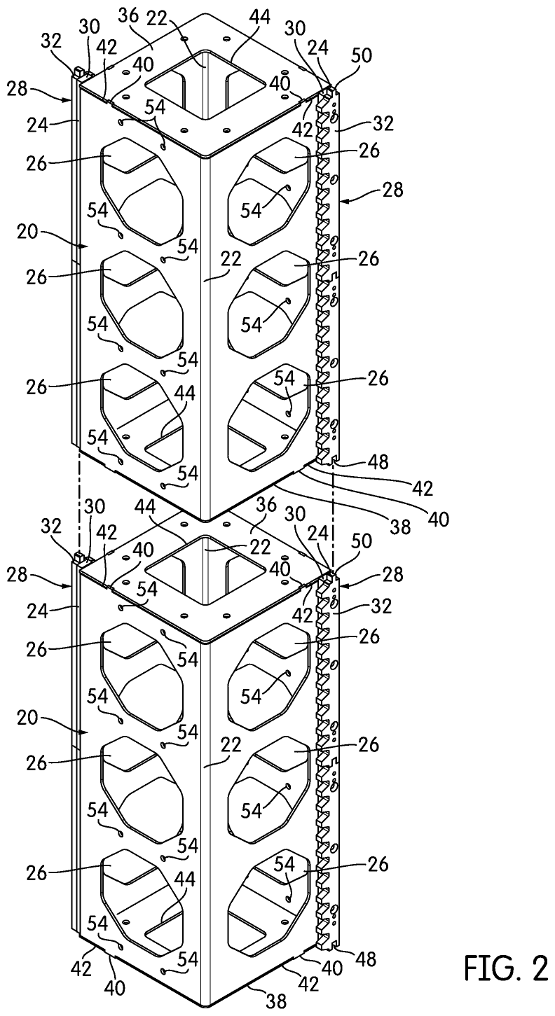

Instead, the segments 18, 20 are comprised of pieces of sheet metal. As can be seen in FIG. 1 and in the exploded perspective view of FIG. 2, each segment 18, 20 has a sidewall that is comprised of two pieces of sheet metal, each of which is bent into an L-shape. Thus, the sidewall of each segment has two bent corners 22 and two welded corners 24, and two weldments are sufficient to join the sidewall of each of the segments 18, 20. Each face of each rectilinear segment 18, 20 has an open area 26. The open areas 26 are provided both to reduce wind-loading on the mast 12 and to reduce the weight of each segment 18, 20. In the illustrated embodiment, the open area 26 is in the shape of an octagon centered on each face. The inventors have found that the octagonal shape of the open area 26 allows more material to be removed, although circles and other shapes may be used in other embodiments.

Each segment may be constructed e.g., by taking a sheet of metal, cutting the open area 26, bending, and welding. Generally speaking, it is advantageous to make each segment as light as possible while retaining the stiffness and stability necessary to extend a reasonable height. For example, in the illustrated embodiment, the mast 12 may reach a height of 70 feet (21 meters) freestanding, and more than 300 feet (91 meters) when tethered to a building. To reduce weight, most of the segments 20 are made of aluminum, which is lighter than steel and other conventional materials. For example ⅜-inch (9.5 mm) sheet 6061 aluminum may be used for most segments 20. Most segments 20 are of an easily-handled height, e.g., 60 inches (1.5 m).

The bottom segment 18 may differ from the other segments 20 in at least some embodiments. Because the bottom of the mast 12 may require additional stiffness in order to ensure stability, the bottom segment 18 may be made of steel, and may be welded directly to the base 16. The bottom segment 18 may also be made somewhat taller than the body segments 20 of the mast, e.g., 84 inches (2.1 m). However, to facilitate mating with other segments 20, the bottom segment 18 may otherwise be made to the same dimensions. For example, each type of segment 18, 20 may have a common side width of 23.3 inches (0.59 m) on each side. Although the use of different materials for the bottom segment 18 is advantageous in terms of weight savings, in some embodiments, the segments 18, 20 may all be made of the same material. That material may be steel, particularly if the mast 12 is to be subjected to particularly extreme loading conditions.

As shown in FIG. 2, each segment 18, 20 has two gear rail assemblies 28, set on diagonally opposite corners. Each gear rail assembly 28 includes a spacer bar 30 and a gear rail 32. The gear rail 32 is toothed to engage a gear, as will be described below in more detail. The gear rail 32 and spacer bar 30 may each be made of hardened steel, e.g., 1 inch (2.54 cm) thick. Fasteners 34 secure the gear rail assembly 28 to each corner of the mast segment 18, 20.

Each segment 18, 20 also has a top plate 36 and a bottom plate 38. The top plate 36 and the bottom plate 38 cap each segment 18, 20. As shown, the segments 18, 20 include vertical projections 40 and the top and bottom plates 36, 38 include notches 42 such that the top and bottom plates 36, 38 are aligned correctly on installation. Generally speaking, the shapes of the top and bottom plates 36, 38 match the shapes of the sidewalls of the segments 18, 20: the corners of the top and bottom plates 36, 38 are rounded where the sidewall segments are bent and sharper where the edges are welded. Both of the top and bottom plates 36, 38 have central openings 44, in both cases, squares with rounded corners. The top and bottom plates 36, 38 may be secured by welding or with fasteners.

In the illustrated embodiment, although the segments 18, 20 are mostly symmetrical about several axes, but they are nonetheless given a defined top and bottom. More specifically, the gear rails 32 have cooperating engaging structure that helps gear rail segments from adjacent mast segments 18, 20 to join together. Specifically, one end of each gear rail 32 has a notch 48. The other end of the same gear rail 32 has a corresponding projection 50. Other types of male and female complementary engaging structures may be used.

The segments 18, 20 themselves are secured by bolts inserted through sets of openings 52 in the top and bottom plates 36, 38. The sidewalls of the segments 18, 20 also have sets of openings 54 that may be used to secure structure connectors to connect the mast 12 to external structures. In the illustrated embodiment, these openings 54 are on two opposite sidewalls; the other two sidewalls have no such structures.

In some embodiments, the segments of the mast may be internally braced, e.g., with a rod that traverses from a lower corner to an upper corner on the opposite side of the segment. For example, a reinforcing rod may run between the two opposite corners to which gear rail assemblies 28 are not attached. However, in the illustrated embodiment of the mast 12, the segments 18, 20 are without internal bracing, and the present inventors have found that, for most loading conditions, such bracing is unnecessary.

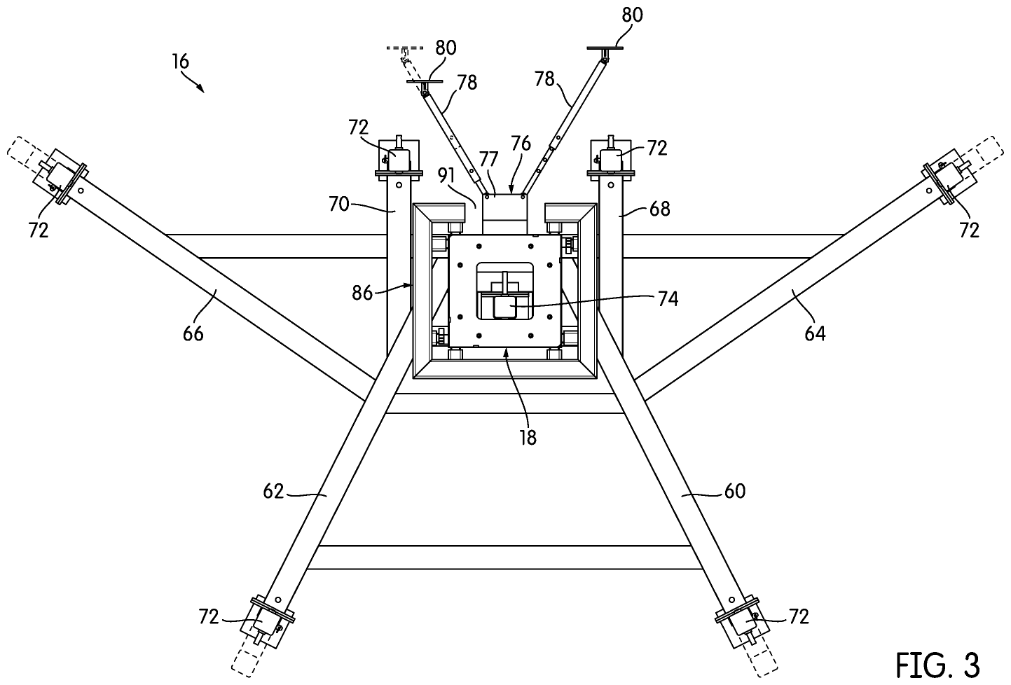

FIG. 3 is a bottom plan view of the base 16, illustrating the connection of the mast 12 with the base 16 and the structure of the base 16 itself. As shown particularly in FIGS. 1 and 3, the bottom segment 18 is welded to the base 16. The base 16 itself is comprised of tubular members, in this case of rectangular cross-section. For example, the tubular members that comprise the base 16 may be 5-inch by 7-inch steel tubes. The base 16 defines a central area 58, where the tubular members meet. The bottom segment 18 is welded to the central area 58 (best seen in the view of FIG. 1. Six legs 60, 62, 64, 66, 68, 70 extend outwardly from the central area 58: two legs 60, 62 diagonally to the sides in front, two legs 64, 66 diagonally to the sides in back, and two legs 68, 70 extending directly back behind the mast 12. The legs 60, 62, 64, 66, 68, 70 are cross-braced, and each one has a leveling foot 72.

As shown in FIG. 3, the legs 60, 62, 64, 66, 68, 70 are extensible and retractable. (For reasons of available space in FIG. 3, the full ranges of extensibility of the legs 60, 62, 64, 66, 68, 70 are not shown.) Generally speaking, when the mast climber 10 is in a freestanding configuration, the legs 60, 62, 64, 66, 68, 70 will be extended to their maximum lengths; when the mast climber 10 is to be tethered to a building or other structure, at least some of the legs 60, 62, 64, 66, 68, 70 will be retracted so that, if possible, the base 16 abuts the building.

The central area 58 of the base 16 has an additional stand or foot 74 that is connected to the central area 58 itself. The additional foot 74 adds stability on center. In some embodiments, the additional foot 74 may also be connected to the interior of the bottom segment 20.

FIG. 3 also illustrates one of the tethering structures 76 that attaches to the openings 54. A bracket or plate 77 attaches to the openings. Two thin, elongate, telescoping members 78 are each independently pivotably attached to the plate 76 on one end and pivotably connected to an attachment plate 80 on the other end. Thus, each of the telescoping members 78 can be individually positioned and individually attached to the building or other support structure. Depending on the expected loading, the way in which the mast climber 10 will be used, and other factors, as many as one or two tethering structures 76 may be used per segment.

### The Platform and Drive

The platform 14 has the form of a box truss, wider than the base 16, but having about the same depth as the base 16. As will be described below, the central portion of the platform 14, proximate to the mast 12, is used to house the drive systems and other moving components of the platform 14; the sides of the platform 14, which are shown as open trusses in the view of FIG. 1, may be covered with various forms of decking when in use. This portion of the platform 14 is covered in the view of FIG. 1, but hatches 82 provide access to the components below. An enclosure 84 on the deck of the platform 14 houses electrical components.

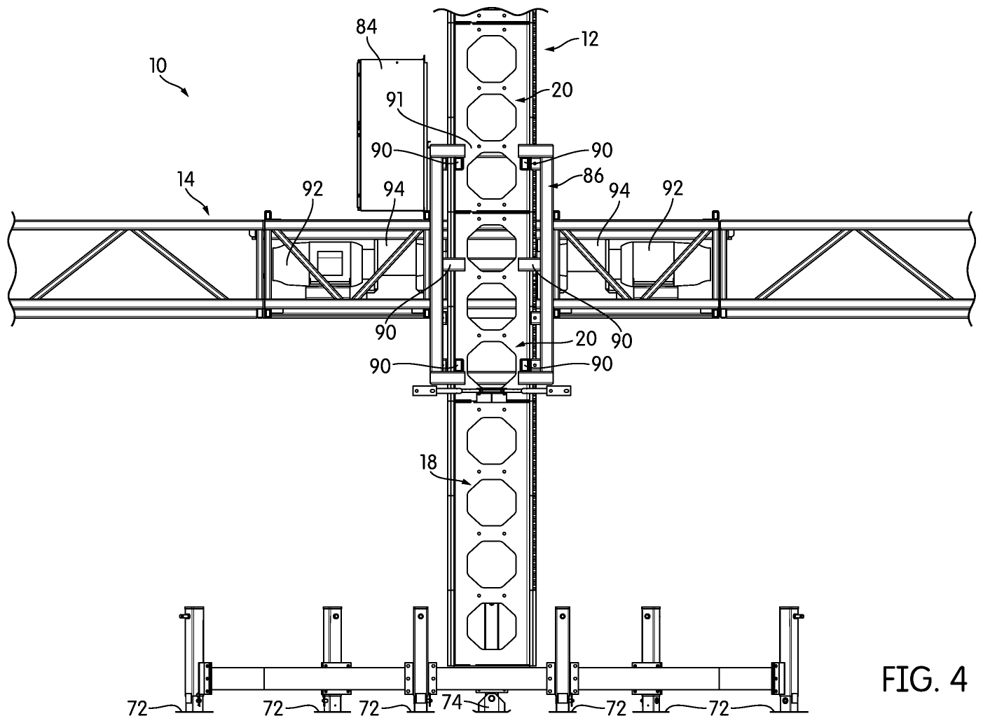

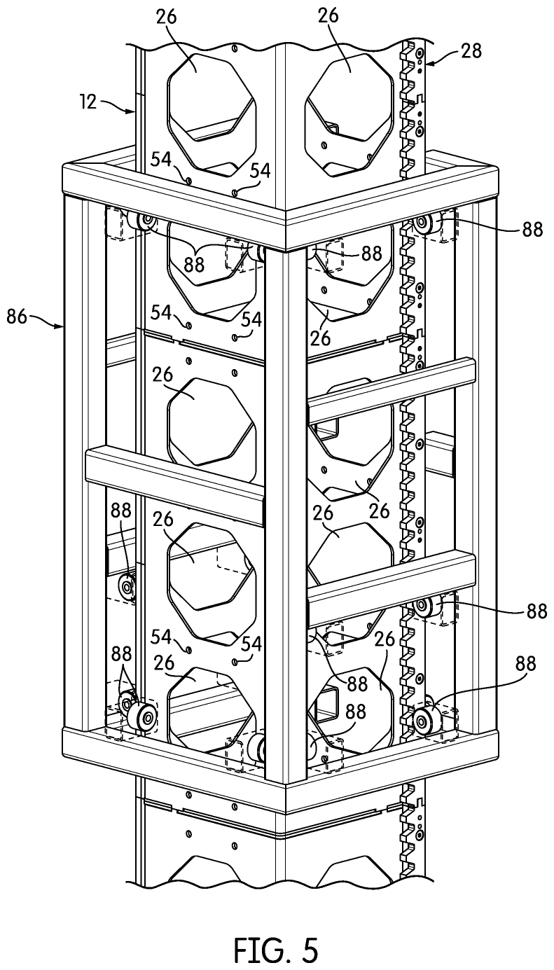

FIG. 4 is a side elevational view of the mast 12 and platform 14. The platform 14 is connected to a cradle 86 that at least partially surrounds the mast 12. FIG. 5 is a close-up perspective view of a portion of the mast 12, showing the cradle in isolation. As shown in both views, the cradle 86 is a rectilinear construct of welded rectangular tube members. The cradle 86 has a number of rollers 88 that bear against the mast 12 as the platform 14 travels up the mast 12. These rollers 88 are mounted on short roller mounts 90. The roller mounts 90 are shown in phantom in FIG. 5 so as to illustrate the rollers 88 without obstruction. The rollers 88 may be made of, e.g., polyurethane, with ball bearings to aid in movement. Because of the cradle 86, the platform 14 is typically in contact with three segments 18, 20 of the mast 12 at any given time.

Notably, the cradle 86 does not completely encircle the mast 12. As shown in FIGS. 3 and 4, the cradle 86 defines a gap 91 that is sufficient to allow the brackets 77 from the tethering structures 76 to extend unobstructed, so that the cradle 86 will not interfere with the securement of the mast 12.

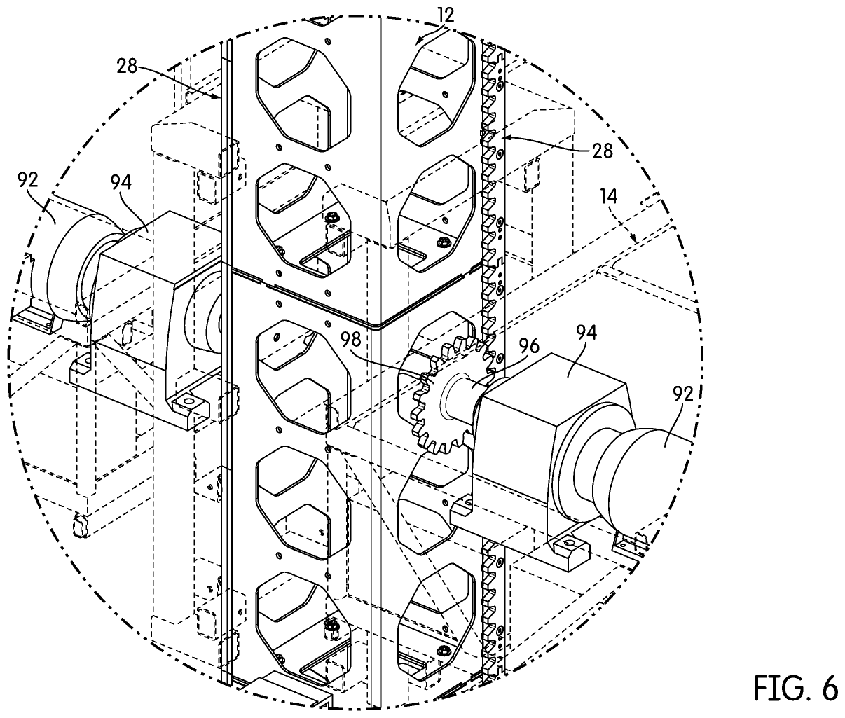

The drive system of the platform 14 is also shown, at least in part, in FIG. 4. Specifically, two motors 92, one for each of the gear rail assemblies 28, drive the platform 14 up and down. Each motor 92 has its own internal brake and transmits power through a transmission 94. FIG. 6 is a close-up perspective view of a portion of the mast 12 and a portion of the platform 14. In the view of FIG. 6, much of the platform 14 is shown in phantom so as not to obscure the details of the motors 94. As shown, each transmission 94 transmits power to a shaft 96. Mounted on each shaft 96 is a gear 98. The gear 98 in this embodiment is an involute gear with 18 teeth, a radius of 7.8 inches to the tips of the teeth, and a radius of 6.36 inches to the roots of the teeth. The gears 98 themselves are each one inch thick and made of steel.

Each of the motors 92 in this embodiment is a 25HP electric motor. The transmissions 94 reduce the 1750 rpm natural speed of these motors 92 to an operating range. In the illustrated embodiment, a variable frequency drive (VFD) further reduces the motor speed controllably to a range that may be as low as 60 rpm. Altogether, the VFD is capable of driving the motors 92 at a range of speeds, ranging from a slow speed of a few feet per minute to speeds like 300 ft/min, which are more commonly seen in elevators. The VFD, whose components may be housed in the enclosure 84 on the platform 14, also serves to coordinate the movements of the two motors 92.

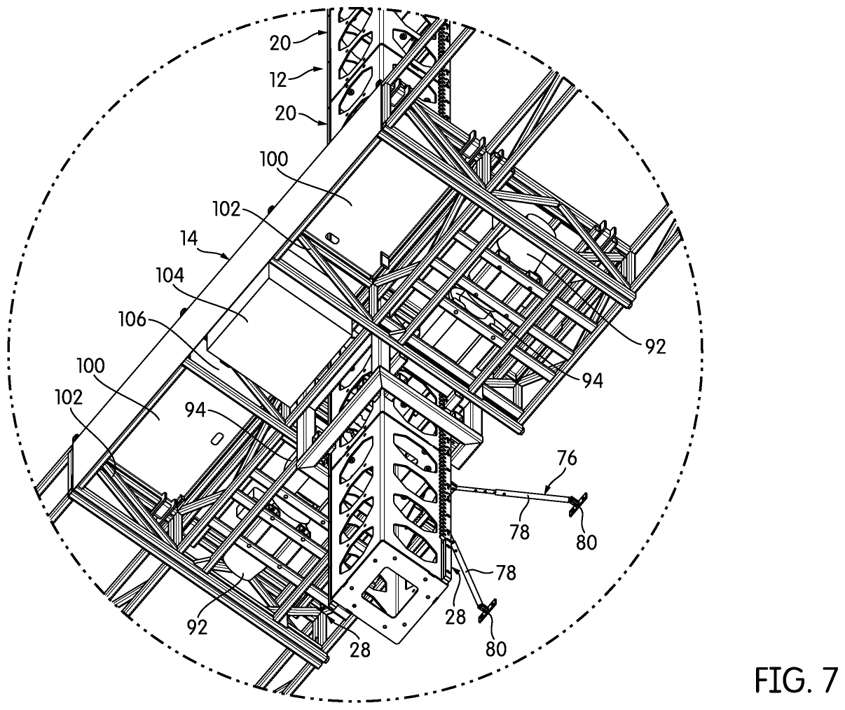

FIG. 7 is a perspective view of the underside of the platform 14 around and proximate to the mast 12. The motors 92 in this embodiment are powered by two batteries 100. These batteries 100 are carried, as can be seen in FIG. 7, in compartments 102 located symmetrically on either side of the mast 12. The symmetrical arrangement of the batteries 100 promotes balance on the platform 14 and greater efficiency in lifting it. In this embodiment, the batteries 100 are lithium batteries, because of their high energy density. The batteries 100 may be, e.g., 25kW·hr batteries, capable of running the motors 92 continuously for one hour.

The advantage of having electric motors 92 and batteries 100 is that the energy to power the motors 92 may be supplied from any number of sources. For example, in some scenarios, solar panels may be installed as decking on the platform 14 to charge the batteries 100 continuously while the mast climber 10 is in operation. In the illustrated embodiment, a generator 104 is installed in its own compartment 106. The compartment 106 in which the generator 104 is installed is essentially in the center of the platform 14, again just adjacent to the mast 12, which is beneficial for the weight distribution and balance of the platform 14.

The generator 104 provides a means of charging the batteries 100, and can also be used for emergency power, should both batteries 100 fail. In the illustrated embodiment, the generator 104 is a 25 kW generator, fueled by gasoline, diesel, or a similar such fuel.

In embodiments of the invention, having a generator 104 onboard is not critical. In some embodiments, a generator may be located off the platform and connected to the batteries 100 via cabling. In other embodiments, the batteries 100 may have sufficient energy to handle typical daily movement, and a generator may be located on the ground to recharge the batteries 100 when the mast climber 10 is not in use.

When considering whether to include a generator 104, one may wish to consider the typical failure and safety scenarios. In the case of a failure or safety issue, most likely, the platform 14 need only deliver its occupants to the next floor down, from which the occupants can evacuate. Thus, in many emergencies, the platform 14 may only need to move a few feet, e.g., 10-20 feet, to accomplish that function. Given that, the capability to fully recharge both batteries 100 may not be necessary. Instead, for example, a third battery may be installed in the central compartment 106 instead of a generator. That third battery may have sufficient capacity, e.g., to power one of the motors 92 for 30 minutes, sufficient time to bring the platform 14 to ground level to evacuate its occupants.

There are other ways in which power may be supplied to the batteries 100. For example, a motor whose output shaft is turned by an outside force becomes an electrical generator and generates power. Thus, when the platform descends, the forced movement of the gears 98 against the gear rails 32 may generate power which can be routed back to the batteries 100. This “backpressure” on the motors 92 may be used in conjunction with other power sources, like solar power, to charge the batteries 100.

As those of skill in the art may note, the availability of power is only one potential safety consideration. Like many systems for which safety is a consideration, the mast climber 10 is preferably overengineered, at least in aspects that relate to safety. For example, the motors 92 may be selected such that only one is sufficient to move the platform 14 or to hold it in place against gravity. Along the same lines, depending on the amount of weight the platform 14 is intended to carry, a single motor 92 and a single gear rail assembly 28 may be sufficient.

While the invention has been described with respect to certain embodiments, the description is intended to be exemplary, rather than limiting. Modifications and changes may be made within the scope of the invention, which is defined by the appended claims.

What is claimed is:

1. A mast climber, comprising:
a mast comprising at least two interconnectable segments, each of the at least two interconnectable segments including
a sidewall comprised of sheet metal,
a top plate,
a bottom plate, and
at least one toothed gear rail secured to the sidewall; and
a platform having a drive system adapted to engage the at least one toothed gear rail.

2. The mast climber of claim 1, wherein each face of the sidewall includes an open area.

3. The mast climber of claim 1, wherein the sidewall comprises two pieces of welded sheet metal, each piece bent such that the sidewall comprises four sides.

4. The mast climber of claim 1, further comprising at least two toothed gear rails secured to the sidewall at opposite corners thereof.

5. The mast climber of claim 4, wherein the at least two toothed gear rails comprise upper and lower complementary engaging structure adapted to engage with vertically adjacent segments of the at least two interconnectable segments.

6. The mast climber of claim 1, wherein the at least two interconnectable segments include a bottom segment and a body segment.

7. The mast climber of claim 6, wherein the bottom segment and the body segment are made of the same material.

8. The mast climber of claim 6, wherein the bottom segment and the body segment are made of different materials.

9. The mast climber of claim 8, wherein the bottom segment is made of steel and the body segment is made of aluminum.

10. The mast climber of claim 1, wherein at least some of the at least two interconnectable segments are made of aluminum.

11. The mast climber of claim 1, wherein the drive system further comprises:
a first electric motor adapted to drive a gear engageable with the at least one toothed gear rail; and
a first battery connected to the first electric motor to supply power.

12. The mast climber of claim 11, further comprising at least two toothed gear rails secured to the sidewall at opposite corners thereof.

13. The mast climber of claim 12, wherein the drive system further comprises:
a second electric motor positioned and adapted to drive a gear engageable with a second of the at least two toothed gear rails; and
a second battery connected to one or both of the first electric motor and the second electric motor to supply power.

14. The mast climber of claim 13, wherein the drive system further comprises a generator connected to the first battery and the second battery.

15. The mast climber of claim 1, wherein each of the at least two interconnectable segments is without internal cross-bracing.
